(19) United States
(12) Patent Application Publication
(10) Pub. No.: US 2016/0217410 A1
(43) Pub. Date: Jul. 28, 2016

(54) Worker Task Assignment Based on Correlation and Capacity Information

(71) Applicant: HEWLETT-PACKARD DEVELOPMENT COMPANY, L.P., Houston, TX (US)

(72) Inventors: CIPRIANO (PANO) A. SANTOS, Palo Alto, CA (US); IVAN ADRIAN LOPEZ, Guadalajara (MX); ETIENNE CANAUD, Shanghai (CN)

(21) Appl. No.: 14/604,256

(22) Filed: Jan. 23, 2015

(51) Int. Cl. G06Q 10/06

(52) U.S. Cl. CPC G06Q 10/063112; G06Q 10/063114

(57) ABSTRACT

Examples disclosed herein relate to worker task assignment based on correlation and capacity information. For example, a processor may create task assignments for workers based on a comparison of task attributes to worker attributes. The number of workers assigned to a task may be based on the availability of workers assigned. The processor may output information related to the task assignments.

### BACKGROUND

A services organization may enter into contracts with multiple entities to fulfill different services obligations, such as services related to IT and software services. The services organization may employ a group of workers that are assigned to various contracts being fulfilled by the services organization.

### BRIEF DESCRIPTION OF THE DRAWINGS

The drawings describe example embodiments. The following detailed description references the drawings, wherein:

FIG. 1 is a block diagram illustrating one example of a computing system to assign a worker to a task based on correlation and capacity information.

FIG. 2 is a flow chart illustrating one example of a method to assign a worker to a task based on correlation and capacity information.

FIG. 3 is a flow chart illustrating one example of method to assign a worker to a task based on correlation and capacity information.

FIG. 4 is a diagram illustrating one example of determining correlation information based on a capacity factor related to worker supply and task demand.

### DETAILED DESCRIPTION

In one implementation, a processor automatically divides tasks into a number of subtasks andassigned to workers based on the availability of selected workers. For example, a processor may create task assignments for workers based on a comparison of correlation scores of the workers to a task such that the number of workers assigned to a task is based on the availability of a selected candidate. A worker may be assigned to a second task where the worker has remaining capacity after the initial assignment. For example, a single task may be assigned to multiple workers and a worker may be assigned to multiple tasks. Services organization may depend heavily on talented individuals, and dividing tasks based on the availability of the most desired workers may results in better task fulfillment.

The correlation information determined by the processor may include a range of factors, such as the capability of the worker to fulfill the task, the capacity of the worker to fulfill the task, and the cost of assigning the worker to the task. Other factors may be included and weighted within a correlation score, such as whether a security clearance is required or whether a worker prefers a particular type of work environment associated with a task. The factors may be weighted to account for the importance of the factors and to allow for information about the factors to be absent, such as where a worker has not provided work environment preference information. The capacity of workers may be compared to the time commitment of the task as part of the correlation score, In addition, there may be a threshold set such that workers available to do less than a standard threshold, such as 20%, or a user defined percentage of a task are not selected despite higher scores related to the capability component.

The processor may select and prioritize workers based on the correlation information, and the workers may be assigned in order according to their priority. For example, a task may be assigned to a first worker in a list according to the amount of the task time commitment the first worker is able to fulfill, and the process may continue to select an additional worker to fulfill the remainder of the task. In one implementation, the stored correlation scores are updated based on the new time commitment of the task as workers previously unable to complete a larger portion of the task may be able to complete a large portion of the remainder of the task unassigned. In some cases, a worker may have capacity to completely fulfill a task, and the worker may be considered for correlation with additional tasks.

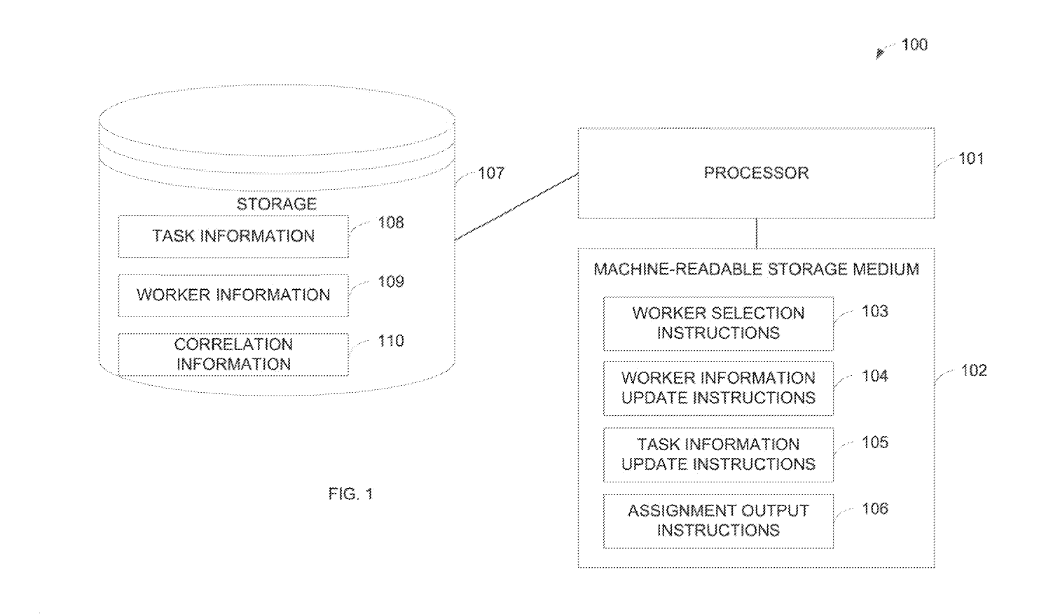

FIG. 1 is a block diagram illustrating one example of a computing system 100 to assign a worker to a task based on correlation and capacity information. The correlation information may include, for example, the capability, capacity, and/or assignment cost of the worker compared to the task. A processor may associate a worker with a task based on correlation information between the task and worker. The processor may assign a portion of the task to the selected worker based on the worker capacity such that a task is automatically divided between workers based on worker capacity. The computing system 100 includes a processor 101, a machine-readable storage medium 102, and a storage 107.

The storage 107 may be any suitable storage for communicating information with the processor 101, such as a database. The storage 107 and the processor 101 may communicate directly or via a network. The storage 107 may store task information 108, worker information 109, and correlation information 110.

The task information 108 may include a list of tasks with associated time commitment and task attribute information. The task attributes ry include, for example, information about the skills associated with the task, the location of the task, and/or the work environment related to the task. The time commitment information may include information about a time commitment in different intervals, such as time commitmentinformation by month. For example, a task may be associated with a large up front time commitment in a first month and a substantially smaller time commitment in a subsequent month.

The worker information 109 may include a list of workers and associated available time capacity and worker attribute information. The available time information may be associated with time periods, such as an amount of available time in a first week and the amount of available time in a second week. The worker attribute information may include, for example, the work experience and education of the worker, skills of the worker, and/or location of the worker.

The correlation information 110 may include information about a correlation between a task and a worker. For example, the processor 101 may determine a correlation score for a task and worker pair and store it in the storage 107. The correlation score may include multiple types of information weighted against each other, such as where a worker preference is weighted as 0.1, worker skills compared to the task is 0.7, and the capacity of the worker compared to the time commitment of the task is 0.2. The individual components of the correlation score may be determined in the same or different manners. For example, a first method may be used to determine a score for worker capability, and a second method may be used to determine worker capacity compared to task time commitment. In one implementation, the method compares a supply of an attribute from a worker to a degree or amount of demand of the attribute by the task, such as where the worker has 120 minutes extra capacity in a time period to supply, and a task demands 140 minutes time commitment in the time period.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include worker selection instructions 103, worker information update instructions 104, task information update instructions 105, and assignment instructions 106.

The worker selection instructions 103 may include instructions to select a worker to associate with a task. The worker may be selected based on the correlation information 110 in the storage 107. For example, the worker with the highest correlation score or a correlation score above a threshold may be selected. The workers may be selected based on a greedy or optimization method. For example, multiple tasks and workers may be considered simultaneously in a manner that optimizes total correlation scores. For example, a graph may be used with worker and tasks nodes to maximize correlation scores associated with connecting lines between the nodes.

The worker information update instructions 104 may include instructions to update the worker information 109 based on assignments. For example, a worker may be removed from the worker information 109 or otherwise marked as not available. The worker information 109 for a selected worker may be updated to indicate the lower capacity of the worker after the assigned task. The new capacity information may be used when determining whether to assign the worker to another task. The processor 101 may determine updated correlation information 110 between the worker and tasks based on the updated worker capacity. For example, the processor may perform a first iteration of an optimization method to make a first set of assignments and repeat the optimization method based on the updated worker information 108.

The task information update instructions 105 may include instructions to update the task information 108. For example, the task may be removed from the task information 108 or otherwise marked to indicate the task has been assigned. The task information 108 associated with the assigned task may be updated to indicate the amount of remaining unassigned time commitment associated with the task after the assignment.

The assignment utput instructions 106 may include instructions to output information related to the assignment, such as to display, transmit, or store the information. The assignment information may be output with information related to multiple assignments, such as a list of assignments for a set of tasks or an individual worker's assignment list.

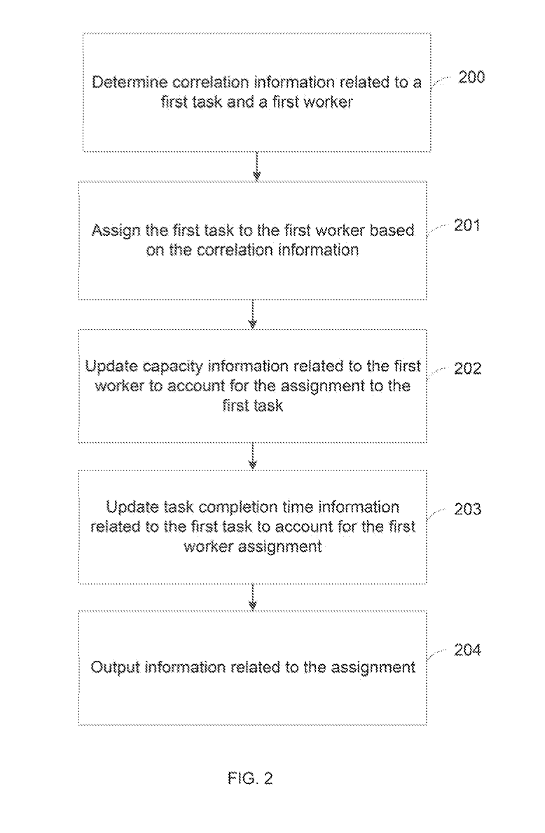

FIG. 2 is a flow chart illustrating one example of a method to assign a worker to a task based on correlation and capacity information. The correlation information may provide any suitable indication of a relationship between the task and the worker related to how suitable the worker is for the task. The correlation information may be, for example, a score, priority, or list. Information about the availability of a worker and a time commitment of a task may be taken into account in the correlation information. A processor may assign a worker to a task based on the correlation information and the amount of available capacity of the worker. For example, the worker may be selected and assigned to the task such that the worker fulfills half of the task due to other time commitments of the worker. The capacity of the worker compared to the time commitment of the task may be taken into account when assigningthe task. For example, the capacity may be taken into account both in relation to the correlation score and in the assignment process. The number of workers assigned to a task and the number of tasks assigned to a worker may be determined automatically based on the time commitment of the selected tasks and the availability of the selected workers. In some implementations, additional iterations of the assignment process are performed to the extent a previous iteration resulted in remaining, worker capacity and/or remaining task time commitment. For example, each iteration may involve an optimization assignment method based on the current capacity and time commitment of the task and workers. The method may be implemented, for example, by the computing system 100 in FIG. 1.

Beginning at 200, a processor determines correlation information related to a first task and a first worker. The correlation information takes into account an available capacity of the first worker and an amount of time for completion associated with the first task. The correlation information may be a score or ranking associated with the suitability of the worker for the task. The correlation information may take into account multiple weighted factors. For example, the weights may add up to 1 and be multiplied by each of the factors such as where the weight for capacity is 0.3, the weight for employee preference is 0.2, and the weight for capability of fulfilling the task is 0.5. The correlation may be taken into account in any suitable manner. The individual correlation components may be determined in any suitable manner. The individual correlation metrics may be determined, for example, using a comparison of the supply of a worker attribute compared to a demand from a task. In one implementation, a correlation is not considered if one of the individual components does not meet a threshold, such as where a capacity correlation value is below a threshold. For example, an assignment process may disregard some potential task and worker pairs.

Continuing to 201, a processor assigns the first task to the first worker based on the correlation information. Any suitable assignment method may be used. The method may be associated with an optimization matching method, such as were the total correlation or subset of correlation total is considered in addition to or instead of individual correlationbetween a task and worker. For example, the method may be incorporated into the cost entity matching method described in U.S. Pat. No. 8,639,563 B2 “Cost Entity Matching” that simultaneously considers multiple takes and workers and multiple options of combinations. As another example, a Hungarian method may be used to select a worker and task for assignment. In one implementation, the processor uses a bi-parte graph G(N,A) where the nodes N are partitioned into two sets, set X of workers and set Y of tasks. The arc A may be set where the correlation score between a worker and task is above a threshold, and the arc value is set to the correlation score. The cost of the assignment may be taken into account by changing the arc value to a penalty value and selecting a worker for a task using a minimum cost assignment method.

The first worker may be assigned to the first task according to the availability of the first worker. For example, if the worker has 10 hours available and the task time commitment is 5 hours, the worker may be assigned 5 hours to the task. If the worker has 10 hours available and the task time commitment is 20 hours, the worker may be assigned to 10 hours to the task.

Continuing to 202, a processor updates capacity formation related to the first worker to account for the assignment to the first task, such as by updating a database or other stored information related to the first worker capacity, For example, the first worker may have additional time capacity than that assigned to the first task. The availability may be based on a particular time period in the planning horizon, such as availability over a three month period. When assigning a worker to a second task, the worker may determine correlation information between the worker and the second task, The correlation information may include information related to the remaining availability of the worker compared to the time commitment of the task. The worker may be selected based on the correlation score and may be assigned according to the remaining time capacity. If additional time capacity remains, the worker may be considered in the selection pool for additional tasks in a future iteration of the process.

Continuing to 203, a processor updates task completion time information related to the first task to account for the first worker assignment. For example, if the task has remaining time commitment unfulfilled by the first worker, the processor may store update time commitment information to indicate the updated demand after the initial assignmen.

Continuing to 204, a processor outputs information related to the assignment. For example, the processor may transmit, store, or display the assignment information. The processor may store the assignment information and transmit or display assignment information related to a set of tasks when the assignments are complete.

The processor may perform a subsequent Iteration of an assignment method to assign the remaining first worker to a second task and/or to assign the remaining first task time to a second worker. The correlation information may be determined again based on the updated time commitment of the task and/or updated capacity of the worker. For example, workers previously not considered or given low correlation scores due to their low availability may have higher scores due to the lower time commitment associated with the task. The same assignment method, such as an optimization method, or another method may be used. The processor may also perform a subsequent iteration on a different worker pool, and/or on a different task pool.

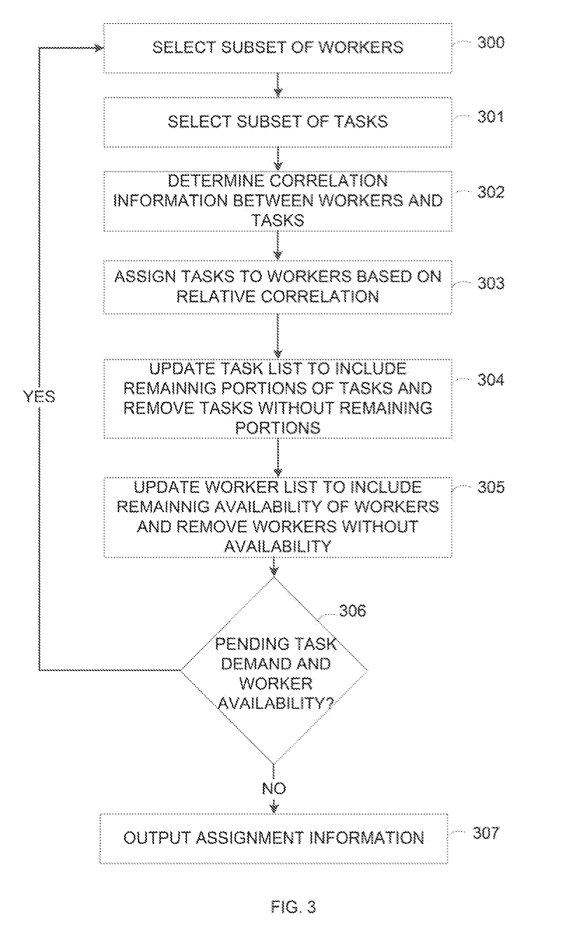

FIG. 3 is a flow chart illustrating one example of method to assign a worker to a task based on correlation and capacity information. The method may be implemented, for example, by a processor executing computer code, such as the processor 101 of FIG. 1.

Beginning at 300, a processor selects a subset of workers. The subset of workers may be selected based on any suitable criteria. For example, a subset of workers may be selected for a particular type of task or based on a particular location. The subset of workers may be selected automatically and/or based on user input provided to a user interface. In one implementation, the subset of workers are based on a priority, such as where higher performing workers are selected for assignment to a group of higher prioritized tasks. In one implementation, an entire pool of workers is selected.

Continuing to 301, a processor selects a subset of tasks. The subset of tasks may be selected automatically and/or based on information received from a user input to a user interface. Tasks may be assigned to priority based task pools, and the tasks may be selected such that higher priority tasks are assigned in an early iteration of the assignment process. In one implementation, there s an ordered list of asks instead of or in addition to a high priority pool.

The processor may determine whether the subset of workers have capacity for the subset of tasks. For example, the processor may determine that the availability of the workers in the subset matches or exceeds the time commitment of the tasks, if not, the processor returns to the worker and task selection. For example, the processor may generate a user interface that requests that a user add more workers to the subset. In one implementation, a message is generated to let the user know that the task assignments will be incomplete. In some implementations, the processor may continue with the assignment and at the end provide information about the remaining unassigned tasks and task portions.

Continuing to 302, the processor determines correlation information between workers and tasks. The correlation information may be determined in any suitable manner. In one implementation, the correlation information is determined differently based on the type of task or other information associated with the task. The correlation information may be weighted factors related to the suitability of the worker to the task. The correlation information may include a factor related to the availability of a worker at a set of time periods compared to the time commitment of a task at each of the set of time periods.

Continuing to 303, the processor assigns a worker to the task based on the relative correlation. For example, the processor may determine a worker from the subset of workers based on the correlation information. The processor may assign the selected worker based on the available capacity of the worker such that the worker is assigned to the time commitment associated with the task to the extent there is availability. The assignment may be made simultaneously, such as based on an optimization method for optimizing total or a subset of correlation scores.

Continuing to 304, the processor updates the task list to include remaining portions of tasks and removes tasks without remaining portions. The processor updates a stored task list to include the remaining portion of the task. For example, the remaining portion of the task may be selected in another round when a task is selected for assignment, if the task is completely assigned, the task may be removed from the subset of available tasks.

Continuing to 305, the processor updates information in a stored worker list to include remaining availability of workers and removes workers without availability. The processor checks whether a portion of the worker capacity is unassigned. If not, at 309, the processor removes the worker from the list. If so, the processor takes into account the updated capacity after the assignment in future correlation scores.

Continuing to 306, the processor determines whether there is pending task demand or worker availability. If there is remaining task demand or worker availability, the processor may continue the process with the updated task and worker lists. For example, the process may continue in another iteration with the same pool of workers and tasks with the updated information, or new subsets of pools may be selected for the future iterations.

If there is not remaining task demand or worker availability, the processor may continue to 307 and output information related to the assignments. In one implementation, the processor causes the assignment information to be displayed on a user interface such that a user may manually make adjustments.

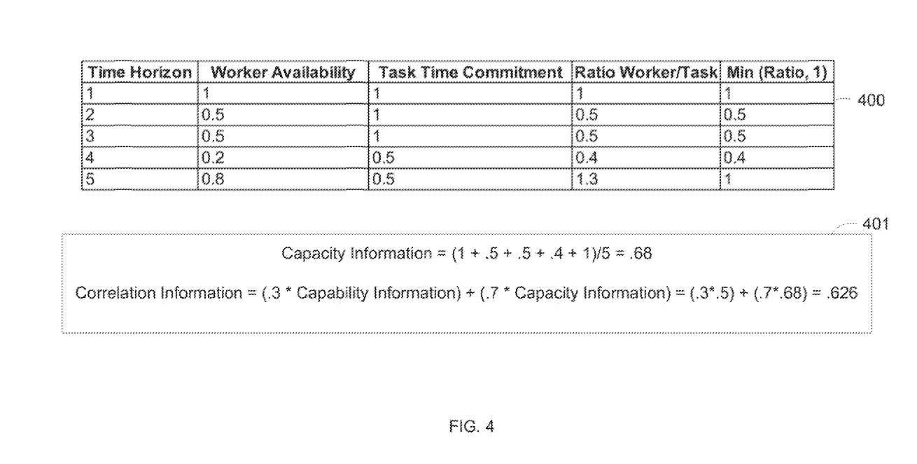

FIG. 4 is a diagram illustrating one example of determining correlation information based on a capacity factor related to worker supply and task demand. For example, the table 400 shows 5 time horizons in column 1, the worker capacity at the different time horizons in column 2, and the task time commitment in the different time horizons in column 3. The fourth column shows a ratio of worker capacity compared to task time commitment. A value of 1 or greater indicates that the workers is able to completely fulfill the task. The fifth column indicates a minimum value between the ratio and 1 so that any time period where the worker is able to completely fulfill the task is indicated by 1. For example, the worker is able to fulfill the task in the first and fifth time periods but not in the others.

Block 401 shows how a processor may determine correlation information from the ratio information in the table 400. Capacity information may be determined by averaging the fifth column, resulting in a value of 0.68. The correlation information may be determined by combining the capacity information with other information. For example, capability information may be weighted with 0.3 and cap city information with 0.7. The resulting correlation score is 0.626 with the weighting of the 0.5 capability score and 0.7 capacity score. The correlation score may be compared to correlation scores of other workers to the task. In some cases, the correlation score may be compared using an optimization method to maximize a total of a set of correlation scores.

A similar method of comparing the task and worker may be used for other factors, such as employee satisfaction, geography, clearance for government contracts and other information. For example, instead of time periods, T may represent different types of geographical information and preferences. The different factors may be weighted and combined in the correlation information. Factors in addition to the capability and capacity may be taken into account with the correlation score, and factors in addition to the correlation score may be used to determine assignments. Including the capacity information in the assignment decision and using the capacity information for the amount of a task assigned to a worker and vice versa allows for a more flexible many to many task and worker assignment scheme.

1. A computing system, comprising:
a storage to store:
a list of tasks with associated time commitment and task attribute information;
a list of workers with associated availability and worker attribute information;
correlation information representing correlations between workers and tasks; and
a processor to:
select a worker to assign to a task based on a comparison of the stored correlation information related to the task;
update the list of tasks to lower the time commitment of the amount of the task remaining after taking into account an assignment to the selected worker; and
update the list of workers to lower the availability of the worker based on the time commitment of the assigned task; and
output information indicating the assignment.

2. The computing system of claim 1, wherein the processor is further to:
select a subset of workers from the list of workers based on the task; and
select the worker to associate with the task from the subset of workers.

3. The computing system of claim 2, wherein the processor is further to:
select a subset of tasks; and
determine whether the subset of workers have the availability to fulfill the subset of tasks.

4. The computing system of claim 1, wherein the process is further to determine the correlation information between a worker and a task based on a comparison of an availability of a worker and a time commitment of a task.

5. The computing system of claim 4, wherein the processor is further to determine the correlation information based on a comparison of a weighting of the time commitment and availability to a weighting of a comparison of a second task attribute and a second worker attribute.

6. The computing system of claim 1, wherein the processor is further to prioritize the tasks within the list of tasks and select a task to assign based on the priority.

7. A method, comprising:
determining, by a processor, correlation information related to a first task and a first worker, wherein the correlation information takes into account an available capacity associated with the first worker and an amount of time for completion associated with the first task:
assigning the first task to the first worker based on the correlation information
updating capacity information related to the first worker to account for the assignment to the first task,
updating task completion time information related to fe first task to account for the first worker assignment; and
outputting information related to the assignment.

8. The method of claim 7, further comrising s subset of workers from which to select the first worker.

9. The method of claim 7, further comprising selecting a subset of available of from which to assign the first worker.

10. The method of claim 7, further comprising performing a subsequent iteration of task and worker assignment based on the updated capacity information and the updated task completion time information.

11. The method of claim 7, wherein the correlation includes a comparison between the first task and the first worker of at least one of: capability, availability, and assignment cost.

12. The method of claim 7, further comprising determining the correlation information based on a comparison of a task demand and worker supply of an attribute taking into account a weight associated with the attribute.

13. A machine-readable non-transitory storage medium comprising instructions executable by a processor to:
create task assignments for workers based on a comparison of task attrib utes to worker attributes,
wherein the task attributes include the availability of the workerscompared to the time commitment of the tasks, and
wherein the number of workers assigned to a task is based on the availability of workers assigned; and
output information related to the task assignments.

14. The machine-readable non-transitor storage medium of claim 13, further comprising instructions to select a subgroup of workers and select a subgroup of tasks to create assignments.

15. The machine-readable non-transitory storagemedium of claim 13, further comprising instructions to compare the task attributes to the worker attributes based on weights associated with the attributes.
